(19) United States
(12) Patent Application Publication
(10) Pub. No.: US 2004/0208711 A1
(43) Pub. Date: Oct. 21, 2004

(54) Mixing device

(76) Inventor: Ingemar Thors, Malung (SE)

Correspondence Address: YOUNG & THOMPSON, 745 SOUTH 23RD STREET 2ND FLOOR, ARLINGTON, VA, 22202

(21) Appl. No.: 10/488,879

(22) PCT Filed: Sep. 6, 2003
(86) PCT No.: PCT/SE02/01596

(30) Foreign Application Priority Data
Sep. 6, 2001 (SE) 0102954-5

(51) Int. Cl. B65G 53/48

(52) U.S. Cl. 406/53

(57) ABSTRACT

The invention refers to a general solution to the problem of establishing, maintaining and re-establishing an even distribution of two or more components in a composite material flow that is conveyed through a pipe. According to the invention teh problem is solved by installing a rotating assembly (b 3) of limited axial length in the pipe, the assembly having wings supported on a common shaft to extend transversely over the flow and generating a radial motion component in the axial flow as they rotate. In a further development of the invention the wings are formed for progressively accelerating the flow from the upstream end (I) of the assembly towards the downstream end (U) thereof.

### TECHNICAL FIELD OF INVENTION

The present invention relates to a mixing device, i.e. an apparatus by which an even distribution between two or more components in a flow of composite material is established, or maintained, or reestablished, in accordance with the preamble of claim 1.

### BACKGROUND AND PRIOR ART

The invention emanates from the technique of insulating walls and joisting with loosely applied insulation fiber material. In this technical field it is a problem to provide an even distribution of fibers in a flow of material that is fed continuously by means of feeding air. The fiber material, such as mineral wool or cellulose fiber conventionally comes in bales that are tightly compressed and needs to be disintegrated by a ripping device that is included in an insulation applying machine. An effective disintegration of the bales and an even distribution of fibers in the feeding air is of importance for a satisfactory insulating capacity, but may however be difficult to achieve by means of the conventional ripping device alone. History has shown that this is true especially when applying cellulose fibers for insulating purposes, such as the so called eco-fibers, wherein tightly compressed lumps of fibers are often observed.

In order to avoid the problem discussed above, the invention suggests an axially operating apparatus for disintegration and mixing of fibers in a feeding air flow.

The invention is likewise applicable within other technical fields where it is desired to establish, maintain or reestablish an even distribution of components in a composite flow of materials. For example, this may be desired for feeding liquids having similar or different densities or viscosities, in processes for production of solutions or suspensions, etc. More precisely, the invention therefore provides a universal apparatus for disintegration and mixing of solids, liquids and gases, wherein at least one of the components may be advanced to operate as a carrier medium.

One main object in the invention is therefore to provide a general solution to the problem of establishing, maintaining or re-establishing an even distribution of one or more components included in a composite, axial flow of materials, contained in a piping.

Another object is to provide a mixing apparatus by which an even admixing of fibers in the feeding air is secured for the distribution of loosely applied insulation fibers.

These and other objects are met in an apparatus as defined by the characterizing part of claim 1. Advantageous embodiments are defined by the subordinated claims.

Briefly, the invention foresees that in the flow direction of a generally axial material flow, enclosed in a piping, an assembly of limited axial length is installed and driven for rotation in order to generate a radial component in the motion of the axial flow.

In a preferred embodiment, the mixing assembly is arranged for progressively accelerating the flow of material from the upstream end of the apparatus towards the downstream end thereof. Several assemblies may be connected in series, such as for larger transport distances.

### SHORT DESCRIPTION OF DRAWINGS

The invention is more closely described below, reference being made to an embodiment thereof and to the appended diagrammatic drawings, wherein

FIGS. 1a, 1b and 1c are alternative embodiments of a general solution shown in longitudinal sections and end views, respectively;

FIG. 2 is a partially broken longitudinal section through an embodiment of the apparatus according to the invention;

FIG. 3 shows a rotor in the apparatus of FIG. 2;

FIG. 4 shows an alternative rotor in the apparatus of FIG. 2;

FIGS. 5a, 5b and 5c are examples of installations for a mixing assembly according to the invention;

FIG. 6 shows alternative embodiments of wings, carried on the rotor of FIG. 4, and

FIG. 7 shows an alternative power transmission for driving the rotor.

### DETAILED DESCRIPTION OF THE DRAWINGS

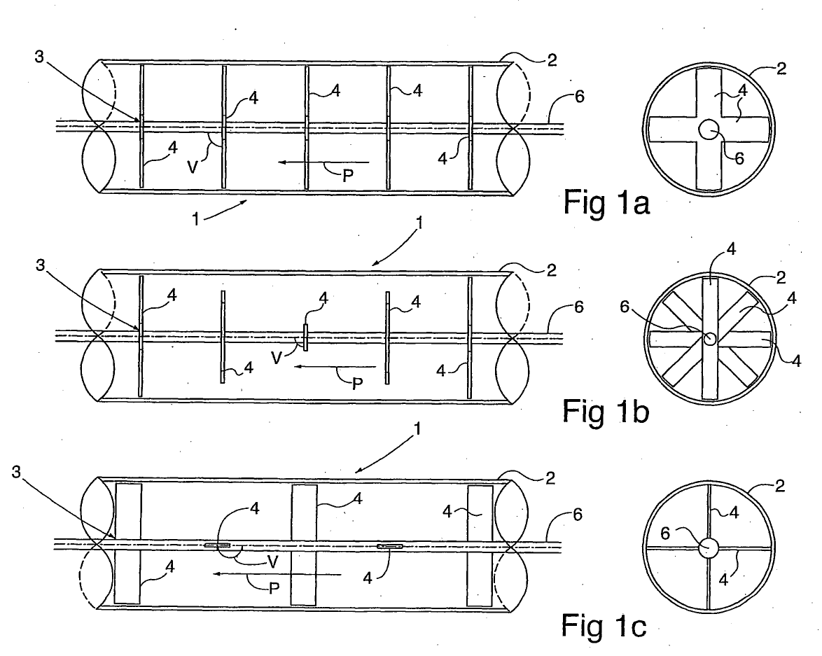

A general solution is described with reference to FIGS. 1a, 1b and 1c, reference figures within brackets referring to elements disclosed in other drawing figures. A mixing assembly 1 according to this invention comprises a rotor 3 driven for rotation and installed in a tube shaped channel or pipe 2. Wings 4 are carried on the rotor and extending radially over the section of flow through the pipe 2. A power means, such as an electric motor (5), is connected-to the rotor to drive the wings preferably at a controllable rotational speed adapted to the flow rate through the pipe, according to arrow P. The assembly 1 is thus supported for rotation (such as through struts or stator elements not further shown) and installed in a pipe designed for conveying a material flow. Multiple assemblies may be arranged successively and axially spaced at varying lengths for establishing, maintaining or re-establishing an even distribution of components included in a flow of materials. One of the components may operate as a carrier medium in the form of a gas or a liquid that is driven through the pipe for transport of one or several admixed materials. The mixture may for example include fibers, solid particles, granulates, liquids and gases, etc., by which it is desirable to achieve an even distribution and mixture of components included in the flow of material. The mixing assembly 1, rotating in the material flow, is driven to generate a radial motion component in the axial flow through the pipe 2.

FIG. 1 thus shows a mixing assembly 1 having multiple blade wings 4 arranged on a common axis 6, a main surface of each wing facing substantially across the flow direction. All wings of FIG. 1a have the same angular orientation on the axis, as is illustrated in the end view of FIG. 1a.

FIG. 1b shows a mixing assembly 1 having wings 4 diametrically extended over the section of flow. Also the wings of FIG. 1b are oriented with a main surface thereof facing substantially across the flow direction, but are however angularly displaced for 45° as is illustrated in the end view accompanying FIG. 1b.

FIG. 1c shows a mixing assembly 1 having wings 4, the main surfaces thereof substantially aligned with the flow direction, and the wings angularly spaced for 90° as according to the accompanying end view.

The wings 4 of FIGS. 1a, 1b accordingly has an angle of attack V of about 90°, as seen radially to the axis 6, while the wings of FIG. 1c have an angle of attack of about 0° (or 180°). Within the scope of this invention, any intermediate attack angle for the wings 4 is conceivable.

The above examples are given to illustrate that the shape, number, attack angle, angular spacing on the axis and other parameters referred to the wings may be varied in consideration of a specific application. As will be understood, the rotational speed of the rotor may likewise be adapted to properties of the individual components included in the conveyed material. Thus it will be understood that an assembly for mixing concrete, e.g., would be driven at a lower rotational speed than would an assembly for foaming detergents fed through the pipe. Accordingly, the mixing assembly 1 may be adapted to various applications to avoid, or to generate cavitation, to effect or not to effect the flow rate, for generating a pressure rise in front or behind the mixing assembly, etc. The adaptation of the mixing assembly for a specific application is more closely described below, reference being made to the other drawing figures.

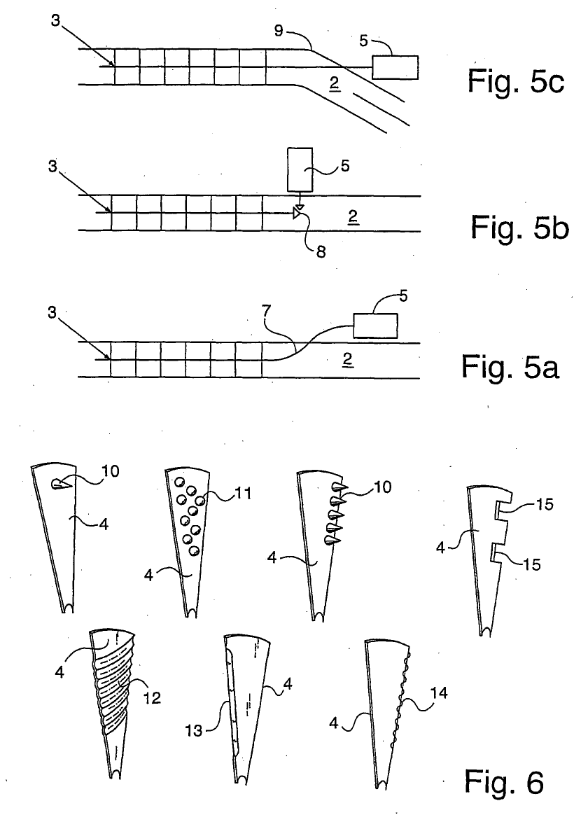

Examples of alternative setups of the assembly shown in FIG. 1 is diagrammatically illustrated in FIGS. 5a, 5b and 5c, respectively. The illustrated examples include a rotor 3 (FIG. 5a), via a flexible shaft 7 connected to a motor 5 that is lying on the pipe exterior, or a rotor 3 (FIG. 5b) that is connected, through a pinion 8, to a motor 5 that is standing on the pipe exterior, or a rotor 3 (FIG. 5c) having a shaft extending through a pipe bend 9 for connection with a motor that is supported outside the pipe bend.

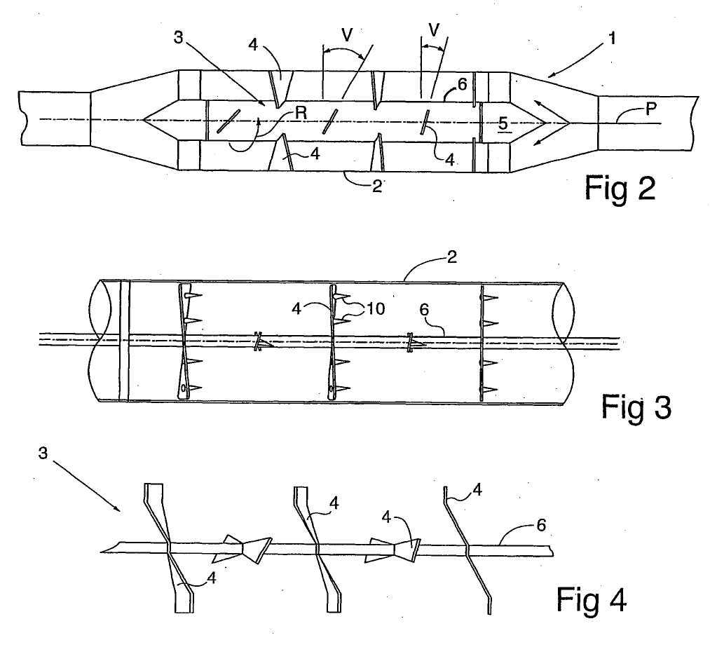

With reference to FIGS. 2 and 3 a further developed embodiment of the mixing assembly according to the invention is disclosed. The rotor 3 comprises a central drive shaft 6, from which the wings 4 are extending in such way that their angle of attack V increases progressively, as seen radially towards the shaft, from the upstream end or inlet I to the downstream end or outlet U, i.e. in the flow direction P.

From the above said it will be obvious that the flow through the assembly is accelerated towards the downstream end, as the wings are driven at equal rotational speed, in the direction of rotation R. Concurrently, the rotating wings will generate a radial motion component in the flow of material, which adapts a worm shaped motion during the passage through the assembly.

It will be seen from the drawings that the wings 4 may be arranged in pairs to extend diametrically from the axis or shaft 6, and that successive pairs of wings may be angularly spaced relative to each other as seen in an axial direction. In the drawing FIGS. 2, 4 and 6 is also shown, by way of example, that the width of each wing may grow progressively in radial direction towards the peripheral end of the wing. Furthermore, the angle of attack V relative to the axial flow direction may grow progressively towards the peripheral end of the wing, and alternatively, the wing surfaces may grow progressively towards the outlet end of the mixing assembly. Without being specifically illustrated in the drawings it shall be noted, that the wings may be designed as cut out portions of a worm screw, and then preferably as portions of a worm screw having a pitch that increases in the flow direction, or as part areas of a doubled worm screw. Another alternative embodiment is illustrated in FIG. 4, comprising wings 4 being alternately bended in the flow direction and towards the flow direction, respectively, in such way that the wing tips are oriented for a uniform axial dividing of the rotor in its longitudinal extension.

With reference to FIGS. 3 and 6, the shown examples illustrate that the wings 4 advantageously may be formed with structures or protrusions that add to the disintegrating capacity and mixing effect of the apparatus. These structures may include protruding teeth or spikes 10, spheres/knobs/cavities 11, grooves or ribs 12, and other structures. The structures may be evenly arranged in patterns or concentrated to the leading or trailing edges of the wing such as illustrated at 14, or arranged at the inner or peripheral end of the wings. The wings may also alternatively be formed as knives having an edge 13 in the leading edge of the wing, or comprise tongues 15 formed through turned op portions of the wing trailing edge.

The operation of the structures may include a disintegrating effect, such as the one provided through the spike 10 shown in FIG. 3, and/or a flow controlling effect such as for affecting the flow radially outwards in order to increase the radial motion component in the flow. The structures are chosen with respect to the components included in the conveyed composite material, and in this connection the spike of FIG. 3 has been found to be effective for disintegration and even admixing of insulation fibers carried by an air flow through the assembly.

Preferably, the apparatus of this invention is driven at a speed of rotation that is adapted to the flow. The rotational speed may be adjusted directly from a powering means for driving the flow, or may be controlled through flow or pressure sensing means in the flow channel. The discharge rate of the apparatus may be determined to provide more or less additional velocity in the flow. Furthermore, the apparatus may be designed to provide a feed resistance, for example realized by adjustment of the angle of attack of the first pair of wings, that will initially cause a compression of the fed material before being treated by the following wings and discharge of the material at a desired feed rate.

In a further developed embodiment (not shown in the drawings), a second rotor is arranged to be axially aligned with the first rotor. This second rotor comprises a second central shaft which is arranged concentrically relative to the drive shaft of the first rotor. The second rotor may be connected to a separate drive means, or via a gear drive connected to a common drive means for rotation in the same or in the opposite direction of rotation as is the first rotor, and at equal or different speeds or rotation.

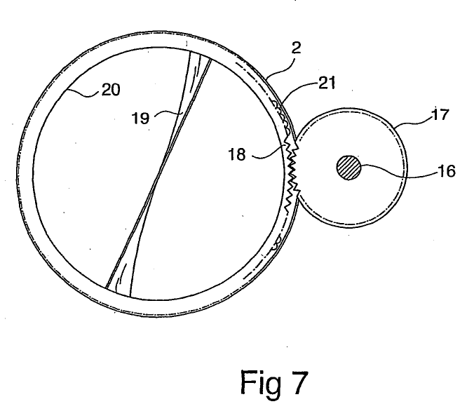

Yet a further development of the invention is diagrammatically illustrated in FIG. 7, showing a section through a set up wherein the assembly is driven from a drive shaft 16 that is supported outside the flow channel and extended in the longitudinal direction of the flow channel. A drive gear 17 on the shaft 16 reaches through the pipe 2 for tangential engagement with an outer gear ring 18 of a wheel 20, having one or several wings 19 supported thereon. The wheel 20 is rotatably supported from the inner wall of the flow channel by means of ring shaped bearing races 21, preferably arranged on each side of the gear ring 18. The wheel 20 itself is shaped as a ring, and carries one or several wings extended within the wheel, diametrically through the center of the ring shaped wheel. The shaft 16 may comprise multiple drive gears 17, arranged in succession and each one separately engaging a wheel 20 that is supported for rotation inside the flow channel and carrying one or several wings 19. Alternatively, the drive gear 17 may be arranged to operatively engage one of a number of wheels 20 included in an assembly of wing carrying wheels that are non-rotationally interconnected. This embodiment may advantageously be dimensioned for mixing and finely distributing heavy and compact materials that require comparatively much energy for processing, such as concrete, asphalt, crude oil, etc.

The invention has proofed to be specifically suitable for mixing and distribution of insulation fibers in a conveying air flow, when the assembly is connected downstream of an insulation machine for disintegration of bales of insulation material. The material is blown into the mixing assembly by means of air, and accelerated from the apparatus to a downstream nozzle from where the fibers are discharged for insulation of walls and joists. If the mixing assembly is connected to or close to an outlet or a nozzle, the assembly may be driven like an ejector for accelerated discharge or mixing of two or more components directly at the nozzle. The invention may also be adapted to various applications where it is desirable to finely distribute or mix solid particles, fluids and gases, and/or desirable to provide the flow with an accelerated discharge rate. It is also conceivable, in applications where this is of advantage, to drive the assembly for generating a resistance in the axial flow such that a fall of pressure over the apparatus is obtained. The accompanying claims are drafted to include all such modifications to the invention that will be apparent from the general solution as disclosed through the above examples thereof.

1.-16. (cancelled)

17. An apparatus for establishing, maintaining or re-establishing an even distribution of two or more constituents included in an axial flow (P) of mixed materials conveyed through a pipe, the apparatus comprising an assembly (3) of limited axial length installed in the pipe and driven for rotation therein, the assembly comprising wings (4,19) extending transversely over the flow and arranged in succession on a common drive shaft (6).

18. The apparatus of claim 17, wherein the wings (4,19) have an angle of attack (V) as seen in radial direction towards the shaft, the attack angle progressively increasing towards a downstream end (U) for accelerating the flow from an upstream end towards the downstream end, and concurrently providing the flow with a radial motion component in the pipe.

19. The apparatus of claim 17, wherein the assembly having a central shaft (6) connected to a drive means (5), and the wings being arranged in pairs to extend diametrically from the shaft.

20. The apparatus of claim 17, wherein the wings are angularly displaced relative to adjacent wings on the shaft.

21. The apparatus of claim 17, wherein the width of each wing increases in a radial direction towards the peripheral end of the wing.

22. The apparatus of claim 18, wherein the attack angle (V) of each wing, relative to the flow direction, is progressively increasing towards the peripheral end of the wing.

23. The apparatus of claim 17, wherein the wings are portions of a worm screw having progressively increasing pitch in the flow direction.

24. The apparatus of claim 17, wherein at least one or some of the wings have one or multiple protrusions (10-15) arranged on a surface facing the flow, the protrusions extending towards the flow above the surface of the wing.

25. The apparatus of claim 24, wherein the protrusions are tooth-shaped.

26. The apparatus of claim 24, wherein a number of protrusions form a regular pattern on said surface of the wing.

27. The apparatus of claim 24, wherein the protrusions (14) are arranged in an area adjacent to the trailing edge of the wing, as seen in the direction of rotation.

28. The apparatus of claim 17, wherein the wings (4) are alternately bent or sloped from the shaft, with and against the flow direction respectively, such that the wing tips are oriented for an even dividing of the rotor in its axial direction.

29. The apparatus of claim 17, wherein one or multiple pairs of additional wings extend from a second central shaft, said additional wings being driven for rotation in the same or opposite direction of rotation as are the wings of said first shaft, and at the same or other rotational speed as the wings of the first shaft.

30. The apparatus of claim 29, wherein said first and, if present, said second central shaft for connection to a drive means is extending through the pipe wall at a pipe bend, formed directly upstream from the assembly.

31. The apparatus of claim 17, wherein the wings (19) are arranged on a wheel (20) separately supported for rotation in the pipe and engaging, via an outer gear ring, a drive gear (17) supported on an external drive shaft (16), the drive shaft (16) extending through the wall of the pipe (2) for tangential engagement with the wheel (20).

32. An apparatus in a machine for loosely applied fiber insulation, by which insulation fibers are carried by air through a channel to a nozzle, the apparatus comprising an assembly (3) of limited axial length installed in the channel upstream of the nozzle and driven for rotation, the assembly progressively accelerating air and fibers from the upstream end (I) towards the downstream end (U) of the assembly, and concurrently providing the flow a radial component in the axial flow within the pipe, the assembly comprising a central shaft (6) connected to a drive means and having radial wings (4) extending transverse to the flow direction, the wings being arranged in succession on the shaft and having an attack angle (V), as seen in radial direction towards the shaft, the attack angle progressively increasing towards the downstream end (U) of the assembly.
